(19) United States
(12) Patent Application Publication
(10) Pub. No.: US 2014/0272786 A1
(43) Pub. Date: Sep. 18, 2014

(54) DEVICE FOR DENTAL, CLEANING, OR OTHER PROCEDURE

(71) Applicant: Jason A. Olsen, Fayetteville, NC (US)

(72) Inventor: Jason A. Olsen, Fayetteville, NC (US)

(21) Appl. No.: 14/183,477

(22) Filed: Feb. 18, 2014

Related U.S. Application Data
(60) Provisional application No. 61/782,573, filed on Mar. 14, 2013.

(51) Int. Cl. A61C 19/00

(52) U.S. Cl. CPC A61C 19/006
USPC 433/163

(57) ABSTRACT

A device for use in an oral healthcare or other procedure includes a ring having a base and two arms extending in opposite circumferential directions. An upstanding receptacle having a flexible wall is mounted on the base. The two arms may partially overlap. Each arm may include a radial tab at a distal end, and a lateral lobe turned toward and overlapping a portion of the other arm. A cup may be inserted into the first receptacle. A pedestal may extend outward from the base within the receptacle. Anti-rotation pins may extend upward from a top surface of the pedestal, the anti-rotation pins contacting and engaging the cup. A sunken receptacle may be formed in the base. A flange extending at inclined angle may overhang the interior space.

### CROSS-REFERENCE TO RELATED APPLICATION

This application claims the benefit of priority of U.S. provisional patent application No. 61/782,573, titled “DEVICE FOR AIDING IN A MEDICAL TREATMENT SUCH AS IN A DENTAL SETTING,” filed on Mar. 14, 2013, which is incorporated herein in its entirety by this reference.

### TECHNICAL FIELD

This disclosure is directed towards a device for aiding in a medical treatment such as in a dental setting, and, more particularly, towards a device used to supplement cleaning of teeth using a hand scraper.

### BACKGROUND

In a dental, orthodontic, or other mouth care related medical office, a healthcare provider such as a dentist, orthodontist, or dental hygienist may use a hand scraper tool for removing plaque and other buildup from teeth. Additionally, a healthcare provider may use other implements, such as, for example, a polishing brush that has paste applied thereon and then is buffed into the patient's teeth. A dentist or dental hygienist will usually have a paper towel or similar paper product nearby in order to deposit excess paste, plaque, and other buildup that the provider uncovers during the healthcare treatment process. In some instances, this may be a bib that is attached around the patient's neck.

Each of these methods and solutions are undesirable for one or more reasons. For example, when a bib is used, the bib and deposited material is viewable to the patient and may be unsightly to the patient and other patients nearby. Additionally, the bib must be immediately disposed of as soon as a treatment such as teeth cleaning is finished and an additional bib may then be required if further medical care is being rendered. When a healthcare provider uses a paper towel, sometimes an assistant may be required to hold the towel. Additionally, the towel may be out of reach from the healthcare provider, slowing down the healthcare treatment process. In the example where an assistant is holding a towel or gauze, the assistant may be injured by inadvertent contact with a sharp medical instrument.

A need therefore exists for a method or solution that addresses these disadvantages.

### SUMMARY

This Summary is provided to introduce in a simplified form concepts that are further described in the following detailed descriptions. This summary is not intended to identify key features or essential features of the claimed subject matter, nor is it to be construed as limiting the scope of the claimed subject matter.

According to at least one embodiment, a device for aiding a user in conducting a procedure includes an encircling structure having a base, a first arm, and a second arm, the first arm and second arm extending in opposite circumferential directions from the base, and a first receptacle mounted on the base, the receptacle having a flexible outer wall surrounding an interior well.

In at least one example, the first arm and second arm at least partially overlap circumferentially such that the base, the first arm, and the second arm together entirely surround an opening. In at least one example, the first arm includes a first distal end circumferentially opposite the base, and a first radial tab at the first distal end extending outward from the encircling structure; and the second arm includes a second distal end circumferentially opposite the base, and a second radial tab at the second distal end extending outward from the encircling structure. In at least one example, the first arm comprises a first lateral lobe at the first distal end, the first lateral lobe turned toward and overlapping a portion of the second arm; and the second arm includes a second lateral lobe at the second distal end, the second lateral lobe turned toward and overlapping a portion of the first arm. In at least one example, the first arm includes a first medial cutout portion overlapped by the second lateral lobe; and the second arm includes a second medial cutout portion overlapped by the first lateral lobe.

In at least one example, a cup is at least partially inserted into the interior well. In at least one example, the encircling structure includes a pedestal extending outward from the base within the interior well and surrounded by the outer wall. In at least one example, the cup can be at least partially inserted into the interior wall contacting the pedestal. In at least one example, anti-rotation pins extend upward from a top surface of the pedestal, the anti-rotation pins contacting and engaging the cup.

In at least one example, slots are formed in the outer wall of the first receptacle. In at least one example, at least one of the slots is at least approximately diametrically opposite another one of the slots. In at least one example, an adhesive layer attaches the first receptacle to the base of the encircling structure.

In at least one example, a second receptacle is formed in the base. In at least one example, the first receptacle includes an upstanding receptacle attached to the base; and the second receptacle includes a sunken receptacle formed in the base. In at least one example, the sunken receptacle defines a dipping well. In at least one example, the dipping well has at least one wall defining an interior space; and a flange extending from the wall at an angle inclined over the interior space. In at least one example, the dipping well is shaped as a flat-bottom cavity having upstanding walls. In at least one example, the dipping well is shaped as a cavity having upstanding walls surrounding a V-channel or cone-shaped recess.

According to at least one embodiment, a device for aiding a user in conducting a procedure includes: an encircling structure having a base, a first arm, and a second arm, the first arm and second arm extending in opposite circumferential directions from the base; an upstanding receptacle mounted on the base, the upstanding receptacle having a flexible outer wall surrounding an interior well; a cup dimensioned to be received in the upstanding receptacle for containing a first material; and a sunken receptacle formed in the base. In at least one example, slots are formed in the flexible outer wall. In at least one example, at least one flange overhangs the sunken receptacle.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

FIG. 1 illustrates a perspective view of device having a base, arms and a debris receiving structure, and a sunken receptacle for use in an oral healthcare or other procedure according to at least one embodiment.

FIG. 2 illustrates a top view of the device of FIG. 1 worn upon a thumb or finger.

FIG. 3 illustrates a cross-sectional view of the device of FIG. 1 taken along the line 3-3 in FIG. 2 and illustrating circumferential overlapping and radial tabs of the arms.

FIG. 4 illustrates a bottom view of the device of FIG. 1, illustrating circumferential overlapping and lateral lobes of the arms.

FIG. 5 illustrates a cross-sectional view of a removable debris receiving structure formed as an upstanding receptacle for attachment as shown in FIG. 1.

FIG. 6 illustrates a perspective view of the removable debris receiving structure of FIG. 5.

FIG. 7 illustrates a cup for placement into the receptacle of the removable debris receiving structure of FIG. 5.

FIG. 8 illustrates in cross-sectional view the cup of FIG. 7 placed into the receptacle of the removable debris receiving structure of FIG. 5.

FIG. 9 illustrates a sunken receptacle formed in the base of FIG. 1 according to at least one embodiment.

FIG. 10 illustrates another sunken receptacle formed in the base of FIG. 1 according to at least one embodiment.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

A device 10 for aiding a user in conducting a procedure such as cleaning teeth is shown in FIGS. 1-4 according to at least one embodiment. For example, the device may to be worn, held, or otherwise utilized by a user conducting an oral healthcare procedure that is medical, preventative, elective, or cosmetic. The device 10 may be worn upon a digit such as a thumb or finger as shown in FIG. 2. For its retention at a desired placement, the device 10 includes a ring 12 formed as an encircling structure defined by two arms 14 and 16 that extend in opposite circumferential directions from a central base 20. The arms 14 and 16 at least partially overlap circumferentially as shown in FIGS. 3-4 such that the base 20 and arms 14 and 16 together entirely surround an opening 22 for receiving a digit or other mounting structure.

The ring 12 is semi-rigid and resilient overall such the central base 20 and arms 14 and 16 together form a compression clamp when placed about a digit or other structure that fits within the opening 22 in a snug or tight fashion. Due to the circumferential overlap, slight flexibility, and resiliency of the base 20 and arms 14 and 16 (FIG. 4), a variety of mounting structures having differing sizes may retain the ring 12. For example, the ring 12 may be donned upon a thumb or finger of a user despite differences in the sizes of such digits. For larger mounting structures, the degree of circumferential overlap of the arms 14 and 16 is lessened upon placing the ring 12. For smaller mounting structures, the degree of circumferential overlap of the arms 14 and 16 is increased upon placing the ring 12. The ring 12, having generally resilient characteristics, may be made from a rubber, metal, polymer, or other flexible yet resilient material. The ring 12 may be machine-washable and be constructed of a material chemically stable against damage from cleaning solutions. In at least one embodiment, the ring 12 is sufficiently durable so as to be sanitized in an autoclave. Each arm 14 and 16 may have a non-slip surface portion 18 (FIG. 1) along an inward facing surface of the arm to promote secure retention of the ring 12 in a preferred orientation.

The arm 14 has a distal end circumferentially opposite its junction with the base 20, and a radial tab 24 at the distal end extending outward from the ring 12. Similarly, the arm 16 has a distal end circumferentially opposite its junction with the base 20, and a radial tab 26 extending outward from the ring 12 (FIG. 3). The circumference of the ring 12 can be increased, widening the opening 22, by squeezing the two radial tabs 24 and 26 toward each other circumferentially. The radial tabs 24 and 26 are illustrated as radially out-turned portions of the circumferentially extending arms 14 and 16. Other tab structures connected to portions of the arms 14 and 16 for adjusting the circumferential overlap of the arms 14 and 16 and/or the compression they apply are within the scope of these descriptions.

The arm 14, at its distal end, has a lateral lobe 34 turned toward and overlapping a medial cutout portion of the arm 16 (FIG. 4). Similarly, the arm 16, at its distal end, has a lateral lobe 36 turned toward and overlapping a medial cutout portion of the arm 14. As such, the maximum size for the opening 22 is reached when the lobes 34 and 36 make contact to define the minimum circumferential overlap of the arms 14 and 16. Thus, the arms 14 and 16 are interlocked by the lateral lobes 34 and 36. The lateral lobes 34 and 36 are illustrated as laterally turned terminal portions of the circumferentially extending arms 14 and 16. Other tab structures connected to portions of the arms 14 and 16 for interlocking or hooking the arms 14 and 16 are within the scope of these descriptions.

The device 10 includes a debris receiving structure 50 (FIG. 1, 3) extending radially outward from the base 20 of the ring 12. The debris receiving structure 50 receives debris such as tartar, plaque, composite and other material collected, for example, during an oral care procedure such as the cleaning of teeth. The debris receiving structure 50 is illustrated as an upstanding receptacle having an annular wall 52 surrounding an interior well 54. For example, a cleaning tool carrying collected debris can be wiped upon the receiving structure 50, particularly the upper end or interior surface of the annular wall 52, to deposit the debris into the interior well 54. To facilitate cleaning of the tool and capture of debris within the well 54, the annular wall 52 is flexible, having slots 56 into which a tool can be pressed for cleaning. For example, a debris-laden tip of a tool may be placed above the interior wall and a medial portion of the tool pressed into a selected slot 56. Then the tip of the tool may be pulled outward through the slot 56, with adjacent portions of the annular wall 52 surrounding the selected slot wiping debris from the tip, leaving the debris within the interior well 54. Various numbers of slots 56 formed through the annular wall 52 in various positions, and various sizes for slots are within the scope of these drawings. Placing multiple slots 56 in diametrically opposite positions relative to each other along the wall 52 advantageously assures that slots 56 are available for use from many angles of approach by a tool upon either hand (left or right) of a user.

The debris receiving structure 50 (FIG. 5) can be formed from a pliable and moisture-absorbing material so as to promote clean conditions and the capture of debris, particularly in fluid, paste, or moistened form. At least the annular wall 52 where the slots 56 are formed is flexible to permit deformation as a tool is pressed into a slot and wiped along an interior portion of the wall. The debris receiving structure 50 is formed from sponge material in at least one embodiment. The debris receiving structure 50 may containing paste, such as buffing paste or any prophy paste and may be provided with one or more characteristics such as an orange pumice scent or flavoring.

In the illustrated embodiment, the debris receiving structure 50 is removable from the ring 12 for disposal or cleaning. As such, the ring 12 can be cleaned and re-used, with a replacement debris receiving structure 50 being applied thereto. As shown in FIG. 6, the debris receiving structure 50, in the illustrated embodiment, includes a removable backing 60 that protects an adhesive layer 62 that attaches the base end of the annular wall 52 to the radially outer side of the base 20 of the ring 12. For example, the backing 60 may include waxed paper or plasticized foil or other layer with a non-stick surface that is releasable from the adhesive layer 62. The adhesive layer 62 may include a pressure sensitive adhesive or other tacky binding material. Thus, the debris receiving structure 50 may be replaceable, each new structure 50 being selectively engaged with the ring 20 for use. The ring 10 may be cleaned and re-used, with a new debris receiving structure 50 being used at each occurrence. Alternatively, the device 10 may be configured as a single use item such that a user disposes of the device 10 after one use.

The device 10 further includes a cup 70 (FIG. 7) for removable insertion into the interior well 54 of the debris receiving structure 50. The cup 70 may, for example, contain dental prophylaxis paste (“prophy”), amalgam, sealant or protectant, or any compound or material preferred by the user. The cup 70 fits into the interior well 54 of the debris receiving structure 70, contacting interior surfaces thereof, for a snug engagement as shown in FIG. 8. The cup includes a cylindrical wall 72 extending from a base 74 to an annular flange 76 extending like a lip from the top of the wall 72.

The ring 12 includes a pedestal 40 (FIG. 3, 8) extending radially outward from the base 20 within the interior well 54 and surrounded by the annular wall 52. Anti-rotation pins 42 extend upward from a top surface of the pedestal 40 to contact and engage the cup 70. This minimizes or prevents rotation of the cup 70 within the interior well 54 of the debris receiving structure 50. This is particularly advantageous when materials are mixed within the cup or when the tip of a polishing tool is rotated within the cup to pick up prophy. As such, the structure 50 serves for wiping clean a tool and receiving debris therefrom, as well as carrying the cup 70.

The ring 12 further includes a dipping well 80 (FIGS. 1-2) formed in the base 20 and opening outward therefrom. The dipping well 80 is illustrated as a sunken receptacle formed in the base 20 separate from the debris receiving structure 50, which is illustrated as an upstanding receptacle attached to the base. The dipping well 80 is useful for containing treatment materials such as fluoride gel, antibacterial cleaner, or other material used in oral medicine, cleaning, and tooth repair. The dipping well may hold composite glue or other fixing compounds for attaching brackets used for orthodontic braces and other oral fixtures.

FIGS. 9-10 illustrated at least two embodiments of the dipping well 80. A dipping well 90 according to at least one embodiment is shown in FIG. 9. The well 90 is shaped as a rectangular cavity. The well 90 has an interior space 92 for containing any desired material or compound. Flanges 94 are attached along upper margins of the walls of the well 90. Each flange 94 extends at an angle inclined over the interior space 92 to block splashing or spillage.

A dipping well 100 according to at least one other embodiment is shown in FIG. 10. The dipping well 100 is shaped as a rectangular cavity having upstanding walls surrounding a V-channel or cone-shaped recess. An interior space 102 for containing any desired material or compound is defined. Flanges 104 are attached along upper margins of the upstanding walls. Each flange 104 extends at an angle inclined over the interior space 102 to block splashing or spillage of the material. Such a V-channel or cone-shaped recess configuration is advantageous toward collecting small amounts or treatment materials and maximizing an angle of acceptance of a tool inserted into the well 100 to retrieve and use the material. The well 100 is thus advantageous toward minimizing waste.

While device 10 has been described with reference to dental applications, for example for collecting debris from a tool used to remove plaque and buildup from a patient's teeth in lieu of collecting the debris on the patient's bib or a nearby towel as is conventionally done in an unsightly manner. The device 10 is equally applicable in any situation in which it may be advantageously employed. For example, device 10 may be used by professionals and hobbyists who use glue, liquids, polishing compounds and other materials carried by or collected in the interior well 54, cup 70, and dipping well 80, for example, shaped as shown in FIGS. 9 and 10.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A device for aiding a user in conducting a procedure, the device comprising:
an encircling structure having a base, a first arm, and a second arm, the first arm and second arm extending in opposite circumferential directions from the base;
a first receptacle mounted on the base, the first receptacle having a flexible outer wall surrounding an interior well.

2. A device according to claim 1, wherein the first arm and second arm at least partially overlap circumferentially such that the base, the first arm, and the second arm together entirely surround an opening.

3. A device according to claim 2, wherein:
the first arm comprises a first distal end circumferentially opposite the base, and a first radial tab at the first distal end extending outward from the encircling structure; and
the second arm comprises a second distal end circumferentially opposite the base, and a second radial tab at the second distal end extending outward from the encircling structure

4. A device according to claim 3, wherein:
the first arm comprises a first lateral lobe at the first distal end, the first lateral lobe turned toward and overlapping a portion of the second arm; and
the second arm comprises a second lateral lobe at the second distal end, the second lateral lobe turned toward and overlapping a portion of the first arm

5. A device according to claim 4, wherein:
the first arm comprises a first medial cutout portion overlapped by the second lateral lobe; and
the second arm comprises a second medial cutout portion overlapped by the first lateral lobe.

6. A device according to claim 1, wherein the encircling structure comprises a pedestal extending outward from the base within the interior well and surrounded by the outer wall.

7. A device according to claim 6, further comprising a cup at least partially inserted into the interior well and contacting the pedestal, wherein anti-rotation pins extend upward from a top surface of the pedestal, the anti-rotation pins contacting and engaging the cup.

8. A device according to claim 1, further comprising a cup at least partially inserted into the interior well.

9. A device according to claim 1, wherein slots are formed in the outer wall of the first receptacle.

10. A device according to claim 9, wherein at least one of the slots is at least approximately diametrically opposite another one of the slots.

11. A device according to claim 1, further comprising an adhesive layer that attaches the first receptacle to the base of the encircling structure.

12. A device according to claim 1, wherein a second receptacle is formed in the base.

13. A device according to claim 12, wherein:
the first receptacle comprises an upstanding receptacle attached to the base; and
the second receptacle comprises a sunken receptacle formed in the base.

14. A device according to claim 12, wherein the second receptacle defines a dipping well.

15. A device according to claim 14, wherein:
the dipping well has at least one wall defining an interior space; and
a flange extending from the wall at an angle inclined over the interior space.

16. A device according to claim 14, wherein the dipping well is shaped as a flat-bottom cavity having upstanding walls.

17. A device according to claim 14, wherein the dipping well is shaped as a cavity having upstanding walls surrounding a V-channel or cone-shaped recess.

18. A device for aiding a user in conducting a procedure, the device comprising:
an encircling structure having a base, a first arm, and a second arm, the first arm and second arm extending in opposite circumferential directions from the base;
an upstanding receptacle mounted on the base, the upstanding receptacle having a flexible outer wall surrounding an interior well;
a cup dimensioned to be received in the upstanding receptacle for containing a first material; and
a sunken receptacle formed in the base.

19. A device according to claim 18, wherein slots are formed in the flexible outer wall.

20. A device according to claim 18, wherein at least one flange overhangs the sunken receptacle.
